(19) United States
(12) Patent Application Publication
(10) Pub. No.: US 2018/0210226 A1
(43) Pub. Date: Jul. 26, 2018

(54) Cushioned Spectacle Assembly

(71) Applicant: Karen Pope, Seguin, TX (US)

(72) Inventor: Karen Pope, Seguin, TX (US)

(21) Appl. No.: 15/415,082

(22) Filed: Jan. 25, 2017

(51) Int. Cl. G02C 5/02; G02C 5/20; G02C 9/04

(52) U.S. Cl. CPC G02C 5/02; G02C 9/04; G02C 5/20

(57) ABSTRACT

A cushioned spectacle assembly for comfortably fitting eyewear to a user includes a frame that is configured to couple to a pair of lens. Each of a pair of arms is hingedly coupled to and extends from a respective opposing end of the frame. A plurality of pads is coupled to a rear face of the frame. The arms are configured to selectively position in a stowed configuration, with the arms positioned substantially parallel to the frame, and a deployed configuration, with the arms are positioned substantially perpendicular to the frame. The arms are configured to couple to a head of the user to couple the frame to the head with the frame positioned in front of eyes and the arms positioned above ears of the user. The pads are configured to abut a brow and cheeks of the user as the frame is coupled to the head.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed Under 37 CFR 1.97 and 1.98

The disclosure and prior art relates to spectacle assemblies and more particularly pertains to a new spectacle assembly for comfortably fitting eyewear to a user.

### BRIEF SUMMARY OF THE INVENTION

An embodiment of the disclosure meets the needs presented above by generally comprising a frame that is configured to couple to a pair of lens. Each of a pair of arms is hingedly coupled to and extends from a respective opposing end of the frame. A plurality of pads is coupled to a rear face of the frame. The arms are configured to selectively position in a stowed configuration, with the arms positioned substantially parallel to the frame, and a deployed configuration, with the arms are positioned substantially perpendicular to the frame. The arms are configured to couple to a head of the user to couple the frame to the head with the frame positioned in front of eyes and the arms positioned above ears of the user. The pads are configured to abut a brow and cheeks of the user as the frame is coupled to the head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a cushioned spectacle assembly according to an embodiment of the disclosure.

FIG. 2 is a top view of an embodiment of the disclosure.

FIG. 3 is an isometric perspective view of an embodiment of the disclosure.

FIG. 4 is a back view of an embodiment of the disclosure.

FIG. 5 is a front view of an embodiment of the disclosure.

### DETAILED DESCRIPTION OF THE INVENTION

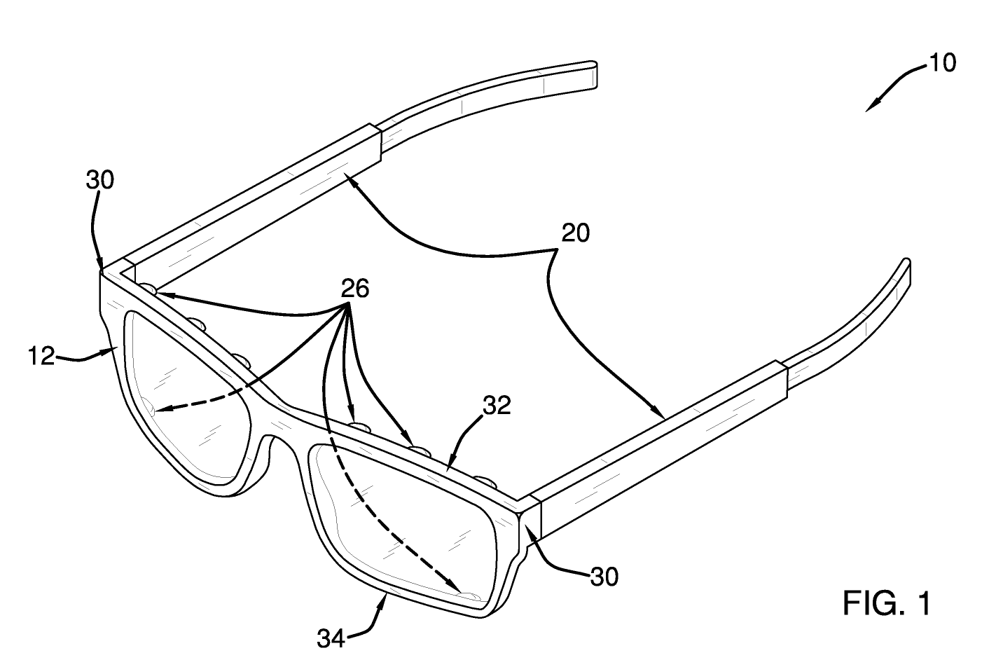

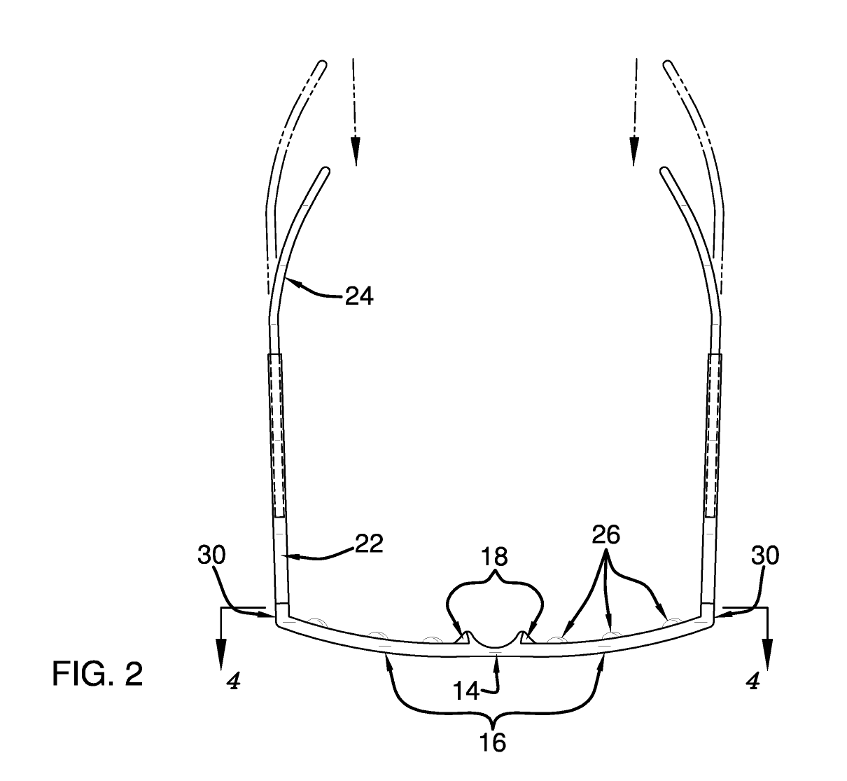

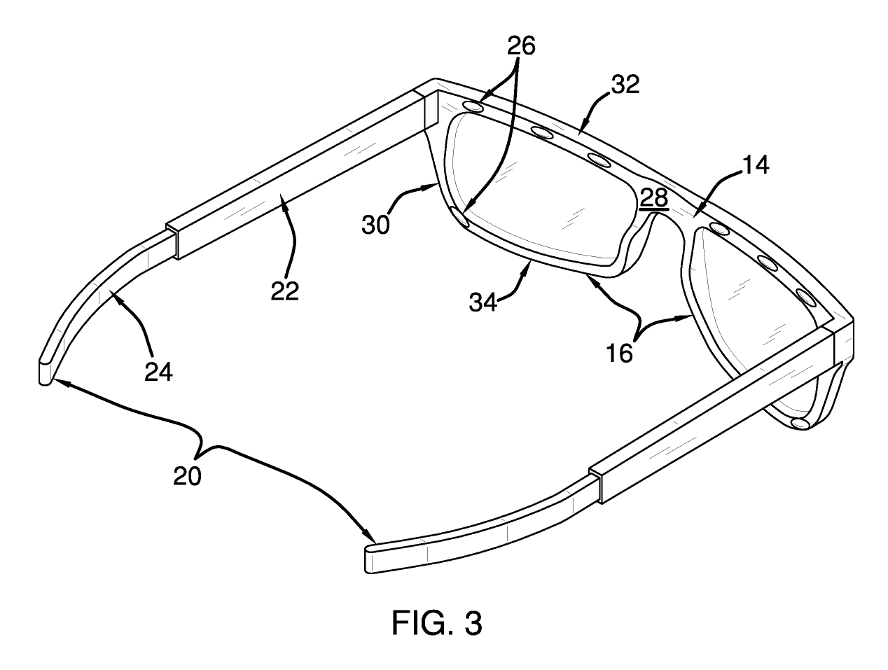

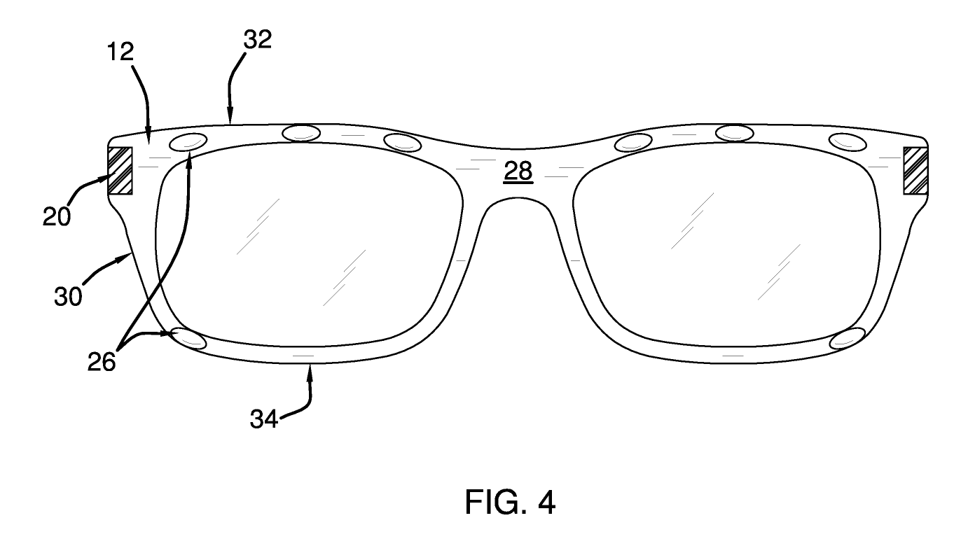

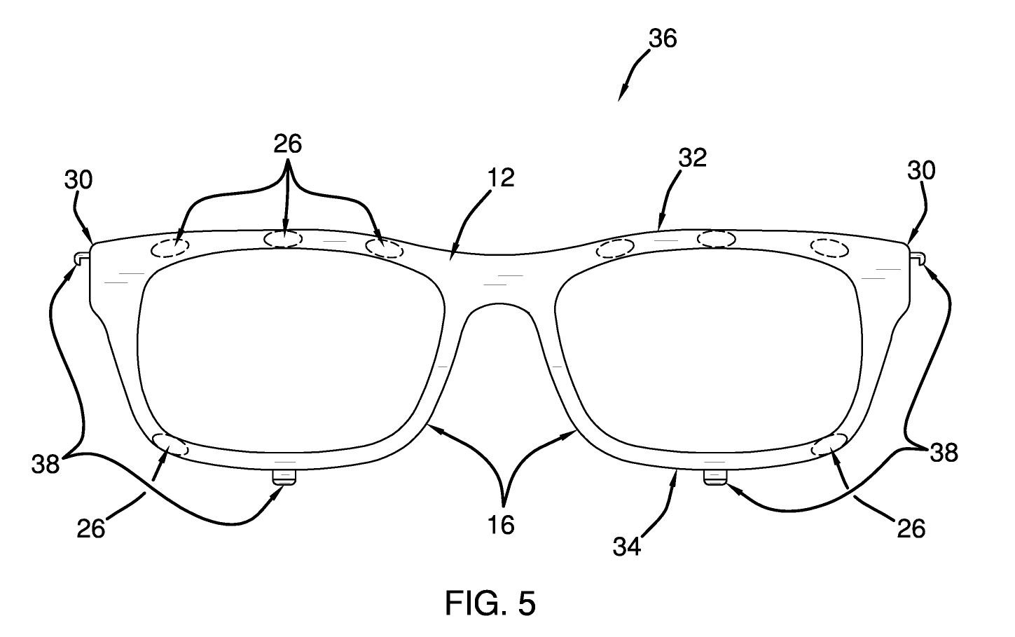

With reference now to the drawings, and in particular to FIGS. 1 through 5 thereof, a new spectacle assembly embodying the principles and concepts of an embodiment of the disclosure and generally designated by the reference numeral 10 will be described.

As best illustrated in FIGS. 1 through 5, the cushioned spectacle assembly 10 generally comprises a frame 12 that is configured to couple to a pair of lens. The frame 12 comprises a bridge 14 and a pair of rims 16. Each rim 16 is coupled to and extends from a respective opposing edge 18 of the bridge 14. The rims 16 are substantially coplanarly positioned.

Each of a pair of arms 20 is hingedly coupled to and extends from a respective opposing end 30 of the frame 12. The arms 20 are configured to selectively position in a stowed configuration and a deployed configuration. In the stowed configuration, the arms 20 are positioned substantially parallel to the frame 12. In the deployed configuration, the arms 20 are positioned substantially perpendicularly to the frame 12. The arms 20 are configured to couple to a head of a user to couple the frame 12 to the head of the user with the frame 12 positioned in front of eyes of the user and the arms 20 positioned above ears of the user.

In one embodiment, each arm 20 comprises a first section 22 and a second section 24. The first section 22 is coupled to the frame 12. The second section 24 is selectively extendable from the first section 22. The second section 24 is selectively configurable to couple the frame 12 to the head of the user. In another embodiment, the second section 24 is flexible and inherently arcuate. The second section 24 is substantially positionable within the first section 22 and is positioned to selectively extend from the first section 22. The second section 24 is configured to couple to a back of the head of the user.

A plurality of pads 26 is coupled to a rear face 28 of the frame 12. The pads 26 are configured to abut a brow and cheeks of the user as the frame 12 is coupled to the head of the user. In one embodiment, the plurality of pads 26 comprises six pads 26 that are positioned proximate to an upper edge 32 of the frame 12. In another embodiment, the plurality of pads 26 comprises two pads 26 that are positioned singly proximate to each opposing end 30 of the frame 12 and a lower edge 34 of the frame 12. In yet another embodiment, the pads 26 are reversibly couplable to the frame 12. Pads 26 with selected thicknesses are couplable to the frame 12 so that the frame 12 is adjustably couplable to the user. In still yet another embodiment, the pads 26 are rounded. In still yet another embodiment, the pads 26 comprise rubber.

The present invention also comprises a clip-on version 36 of the frame 12 lacking the pair of arms 20. A plurality of clips 38 is coupled to and extends from a front face 40 of the frame 12. The clips 38 are positioned on the frame 12 such that the clips are configured to couple to the inside of a pair of glasses. The pads 26 positioned on the rear face 28 of the frame 12 are configured to abut the brow and the cheeks of the user as the pair of glasses is positioned on the head of the user. In one embodiment, the plurality of clips 38 comprises clips 38 that are positioned singly proximate to said upper edge 32 and each said opposing end 30 of said frame 12, as well as clips 38 that are positioned singly on each said rim 16 proximate to said lower edge of said frame 12.

In use, the arms 20 are configured to selectively position in the stowed configuration and the deployed configuration. In the stowed configuration, the arms 20 are positioned substantially parallel to the frame 12. In the deployed configuration, the arms 20 are positioned substantially perpendicularly to the frame 12. The second section 24 is flexible is substantially positionable within the first section 22. The second section 24 is positioned to selectively extend from the first section 22. The first section 22 and the second section 24 are configured to couple the frame 12 to the head of the user with the frame 12 positioned in front of the eyes of the user and the arms 20 positioned above the ears of the user. The pads 26 are configured to abut the brow and the cheeks of the user as the frame 12 is coupled to the head of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cushioned spectacle assembly comprising:
a frame configured for coupling to a pair of lens;
a pair of arms, each said arm being hingedly coupled to and extending from a respective opposing end of said frame;
a plurality of pads coupled to a rear face of said frame; and
wherein said arms are positioned on said frame such that said arms are configured for selectively positioning in a stowed configuration, wherein said arms are positioned substantially parallel to said frame, and a deployed configuration, wherein said arms are positioned substantially perpendicularly to said frame such that said arms are configured for coupling to a head of a user to couple said frame to the head of the user positioning said frame in front of eyes of the user and said arms above ears of the user, wherein said pads are positioned on said frame such that said pads are configured for abutting a brow and cheeks of the user as said frame is coupled to the head of the user.

2. The assembly of claim 1, further including said frame comprising a bridge and a pair of rims, each said rim being coupled to and extending from a respective opposing edge of said bridge such that said rims are substantially coplanarly positioned.

3. The assembly of claim 1, further including each said arm comprising a first section and a second section, said first section being coupled to said frame, said second section being selectively extendable from said first section, wherein said second section is selectively extendable from said first section such that said second section is selectively configurable to couple said frame to the head of the user.

4. The assembly of claim 3, further including said second section being inherently arcuate, said second section being flexible such that said second section is substantially positionable within said first section and wherein said second section is positioned for selectively extending from said first section such that said second section is configured for coupling to a back of the head of the user.

5. The assembly of claim 1, further including said plurality of pads comprising six said pads positioned proximate to an upper edge of said frame.

6. The assembly of claim 5, further including said plurality of pads comprising two said pads positioned singly proximate to each said opposing end of said frame and a lower edge of said frame.

7. The assembly of claim 1, further including said pads being reversibly couplable to said frame such that said pads having selected thicknesses are couplable to said frame such that said frame is adjustably couplable to the user.

8. The assembly of claim 1, further including said pads being rounded.

9. The assembly of claim 1, further including said pads comprising rubber.

10. The assembly of claim 1, further comprising a clip-on version of said frame, said clip-on version comprising:
omitting said pair of arms, and
a plurality of clips coupled to and extending from a front face of said frame; and
wherein said clips are positioned on said frame such that said clips are configured to couple to an inside of a pair of glasses such that said pads said are positioned on said rear face of said frame are configured to abut the brow and the cheeks of the user as the pair of glasses is positioned on the head of the user.

11. The assembly of claim 10, further including said plurality of clips comprising said clips positioned singly proximate to said upper edge and each said opposing end of said frame, as well as said clips positioned singly on each said rim proximate to said lower edge of said frame.

12. A cushioned spectacle assembly comprising:
a frame configured for coupling to a pair of lens, said frame comprising a bridge and a pair of rims, each said rim being coupled to and extending from a respective opposing edge of said bridge such that said rims are substantially coplanarly positioned;
a pair of arms, each said arm being hingedly coupled to and extending from a respective opposing end of said frame, wherein said arms are positioned on said frame such that said arms are configured for selectively positioning in a stowed configuration, wherein said arms are positioned substantially parallel to said frame, and a deployed configuration, wherein said arms are positioned substantially perpendicularly to said frame such that said arms are configured for coupling to a head of a user to couple said frame to the head of the user positioning said frame in front of eyes of the user and said arms above ears of the user, each said arm comprising a first section and a second section, said first section being coupled to said frame, said second section being selectively extendable from said first section, wherein said second section is selectively extendable from said first section such that said second section is selectively configurable to couple said frame to the head of the user, said second section being inherently arcuate, said second section being flexible such that said second section is substantially positionable within said first section and wherein said second section is positioned for selectively extending from said first section such that said second section is configured for coupling to a back of the head of the user;
a plurality of pads coupled to a rear face of said frame, wherein said pads are positioned on said frame such that said pads are configured for abutting a brow and cheeks of the user as said frame is coupled to the head of the user, said plurality of pads comprising six said pads positioned proximate to an upper edge of said frame, said plurality of pads comprising two said pads positioned singly proximate to each said opposing end of said frame and a lower edge of said frame, said pads being reversibly couplable to said frame such that said pads having selected thicknesses are couplable to said frame such that said frame is adjustably couplable to the user, said pads being rounded, said pads comprising rubber; and
wherein said arms are positioned on said frame such that said arms are configured for selectively positioning in the stowed configuration, wherein said arms are positioned substantially parallel to said frame, and the deployed configuration, wherein said arms are positioned substantially perpendicularly to said frame, wherein said second section is flexible such that said second section is substantially positionable within said first section, wherein said second section is positioned for selectively extending from said first section such that said first section and said second section are configured for coupling said frame to the head of a user positioning said frame in front of eyes of the user and said arms above ears of the user, wherein said pads are positioned on said frame such that said pads are configured for abutting the brow and the cheeks of the user as said frame is coupled to the head of the user.

13. The assembly of claim 12, further comprising a clip-on version of said frame, said clip-on version comprising:
said pair of arms being omitted, and
a plurality of clips coupled to and extending from a front face of said frame, said plurality of clips comprising said clips positioned singly proximate to said upper edge and each said opposing end of said frame, as well as said clips positioned singly on each said rim proximate to said lower edge of said frame; and
wherein said clips are positioned on said frame such that said clips are configured to couple to an inside of a pair of glasses such that said pads said are positioned on said rear face of said frame are configured to abut the brow and the cheeks of the user as the pair of glasses is positioned on the head of the user.
